(19) United States
(12) Patent Application Publication
(10) Pub. No.: US 2013/0313366 A1
(43) Pub. Date: Nov. 28, 2013

(54) LOW DRAG PASSENGER-CABIN WINDOW

(71) Applicants: Thomas S. Hoffa, Torrance, CA (US); Kelvin B. Hsieh, Garden Grove, CA (US)

(72) Inventors: Thomas S. Hoffa, Torrance, CA (US); Kelvin B. Hsieh, Garden Grove, CA (US)

(73) Assignee: GKN Aerospace Transparency Systems Inc., Garden Grove, CA (US)

(21) Appl. No.: 13/902,707

(22) Filed: May 24, 2013

Related U.S. Application Data
(60) Provisional application No. 61/652,074, filed on May 25, 2012.

(51) Int. Cl. B64C 1/14

(52) U.S. Cl. CPC B64C 1/1484
USPC 244/129.3

(57) ABSTRACT

A low drag passenger-cabin window for use on an aircraft fuselage having a generally cylindrical shape, in which the as-manufactured geometry of the window is modified so that the shape of the window at cruise altitudes is aerodynamically optimized. The window comprises a pane of transparent material. The inner and outer surfaces of the peripheral portion of the pane as manufactured conform to a generally cylindrical shape, while the inner and outer surfaces of the medial portion of the pane as manufactured are depressed inwardly in a prescribed manner relative to the peripheral portion. The surfaces of the medial portion are adapted to deflect outwardly to conform to a generally cylindrical shape in response to a predetermined air pressure differential and/or a predetermined temperature gradient experienced at cruise altitude.

### CROSS-REFERENCE TO RELATED APPLICATION

The present application claims priority to U.S. Provisional Application No. 61/652,074, entitled “Low Drag Passenger-Cabin Window,” filed on May 25, 2012, the entire contents of which are herein incorporated by reference as if fully set forth herein.

### BACKGROUND OF THE INVENTION

The present invention relates generally to passenger-cabin windows on airplanes, and more particularly to passenger-cabin windows on airplanes allowing for greater aerodynamics and lower drag.

Cabin windows are generally made with a stretched acrylic material. The typical cabin window is installed in an aircraft fuselage section having cylindrical geometry and so the cabin window is manufactured with a cylindrical curvature matching that of the aircraft. When installed, the edge of the window is restrained by the mating aircraft fuselage structure. When pressurized, the center of the window may bulge outward, forming a compound curved shape that can create undesirable aerodynamic drag. Typical passenger aircraft have a large number of windows and maximum displacements can be approximately 0.300″ or more. These factors lead to a significant increase in drag.

The trend in the industry is towards larger passenger windows which increase passenger comfort and viewing. Larger windows can result in substantially greater deflections. The industry is also placing a greater emphasis on reducing aerodynamic drag to improve fuel economy and range and requirements on the maximum deflection of passenger windows are being given to the passenger window suppliers while still maintaining strict weight requirements.

Sky-rocketing fuel costs have made fuel efficiency of the utmost importance in aircraft design. It is therefore a goal to make the outside contour of an airplane as aerodynamic as possible during operation. The traditional construction of cabin windows creates a situation where during landing and takeoff, the aircraft retains its aerodynamic cylindrical shape because there is minimal to no pressurization. While the plane is in flight, the cabin windows deflect outward and no longer create the aerodynamic cylindrical shape with the cabin body and increase drag. In other words, the “drag penalty” is currently placed on the cruise portion of the flight, while there is no drag penalty during the climb and descent phases of a flight. This is not ideal for fuel efficiency due to the fact that the cruise portion of a flight is generally much longer than the climb and descent phases of a flight.

Previous approaches to control deflection of passenger windows have included several methods. In one such method, high modulus transparent materials, such as glass, have been used instead of stretched acrylic. These materials deflect less than stretched acrylic, and thus lead to less drag when the plane is in flight. However, these materials require a substantial weight penalty and also, due to their greater thermal conductivity, require heating to prevent fogging of the windows. These weight and energy penalties reduce fuel efficiency. Bi-layer configurations have also been attempted, with constructions made from both glass and plastic. This approach, while decreasing the weight penalty, is still heavier than an all-acrylic construction. The glass/plastic construction also changes shape with temperature, leading to greater drag.

Another method for controlling deflection of passenger windows involves increasing the thickness of the stretched acrylic ply or plies. Increasing the thickness would decrease the deflection of the material, but would, like glass, require additional weight as the plies are thicker than required to meet the structural certification requirements of the window.

In yet another method for controlling deflection of passenger windows, the cabin window is bolted to the airframe in place of the more typical clamped-in-place plug window design. This approach creates membrane tension in the window that offsets the window deflection under pressure loads. However, this approach is limited in its effectiveness due to the difference in thermal expansion between stretched acrylic and the aluminum or carbon aircraft structure. Because of differential thermal expansion between stretched acrylic and the aluminum or carbon aircraft structure, there must be some clearance between the bolts and window holes, limiting the amount of tension that can be developed. This approach can be effective at limiting deflections, but there is a weight and cost penalty due to the fasteners and associated hardware.

Another previous approach to controlling deflection involves using an additional exterior transparent pane that is flush with the aircraft skin and has equal pressure on both sides during flight. The cabin pressure is maintained by a structure window mounted further inboard which can deflect into the air gap between it and the fairing pane without protruding into the airstream. However, this solution, once again, leads to a weight penalty to add an additional pane to each window.

It can readily be appreciated that there is a need for cabin windows that are able to increase fuel-efficiency by minimizing drag caused by deflections while also minimizing the weight and cost penalties associated with applying the solution. It can also be readily appreciated that there is also a need for cabin windows that increase fuel-efficiency by shifting the placement of the drag penalty onto the shortest parts of a flight, climb and descent, rather than the longer cruise portion of the flight. The present invention fulfills these needs and provides further related advantages.

### SUMMARY OF THE INVENTION

The present invention resides in a low drag passenger cabin window for use on an aircraft fuselage having a generally cylindrical shape, the window comprising a pane of transparent material having an outer surface and an inner surface, and the pane further having a peripheral portion and a medial portion. The inner and outer surfaces of the peripheral portion of the pane conform to a generally cylindrical shape. The inner and outer surfaces of the medial portion of the pane depress inwardly in a prescribed manner relative to the cylindrical shape of the peripheral portion, wherein the magnitude of the depression of the surfaces of the medial portion relative to the peripheral portion gradually increases from the peripheral portion toward the center of the medial portion. In one embodiment, the subject invention addresses the problem of window deflection at cruising altitudes, thus allowing for decreased drag and greater fuel efficiency.

The surfaces of the medial portion are adapted to deflect outwardly to conform to a generally cylindrical shape in response to a predetermined air pressure differential between the inner and outer surfaces of the pane. Alternatively, or in addition, the surfaces of the medial portion are further adapted to deflect outwardly to conform to a generally cylindrical shape in response to a predetermined temperature gradient on the pane.

The surfaces of the medial portion may deflect to a generally cylindrical shape substantially conforming to the generally cylindrical shape of the peripheral portion. Alternatively, the surfaces of the medial portion deflect to a generally cylindrical shape extending beyond the generally cylindrical shape of the peripheral portion.

The pane may comprise a plastic material, or more particularly an acrylic plastic material. Preferably the acrylic plastic material comprises a stretched acrylic.

Other features and advantages of the invention should become apparent from the following description of the preferred embodiments, taken in conjunction with the accompanying drawings, which illustrate, by way of example, the principles of the invention.

### BRIEF DESCRIPTION OF THE DRAWINGS

Embodiments of the present invention will now be described, by way of example only, with reference to the following drawings.

FIG. 1 is a multi-perspective view of a low drag passenger-cabin window, in accordance with an embodiment of the present invention, compared to the same view of a traditional design cabin window.

FIG. 2 is a deformed shape comparison at cruise conditions to compare outward deflection of a low drag window, in accordance with an embodiment of the present invention, with the outward deflection of a traditional window.

FIG. 3 is a chart comparing a low drag window, in accordance with an embodiment of the present invention, with a traditional window.

FIG. 4 is a length-wise and cross-section view of a cylindrical fuselage and deformed fuselage skins due to internal pressure loads.

### DETAILED DESCRIPTION OF THE PREFERRED EMBODIMENTS

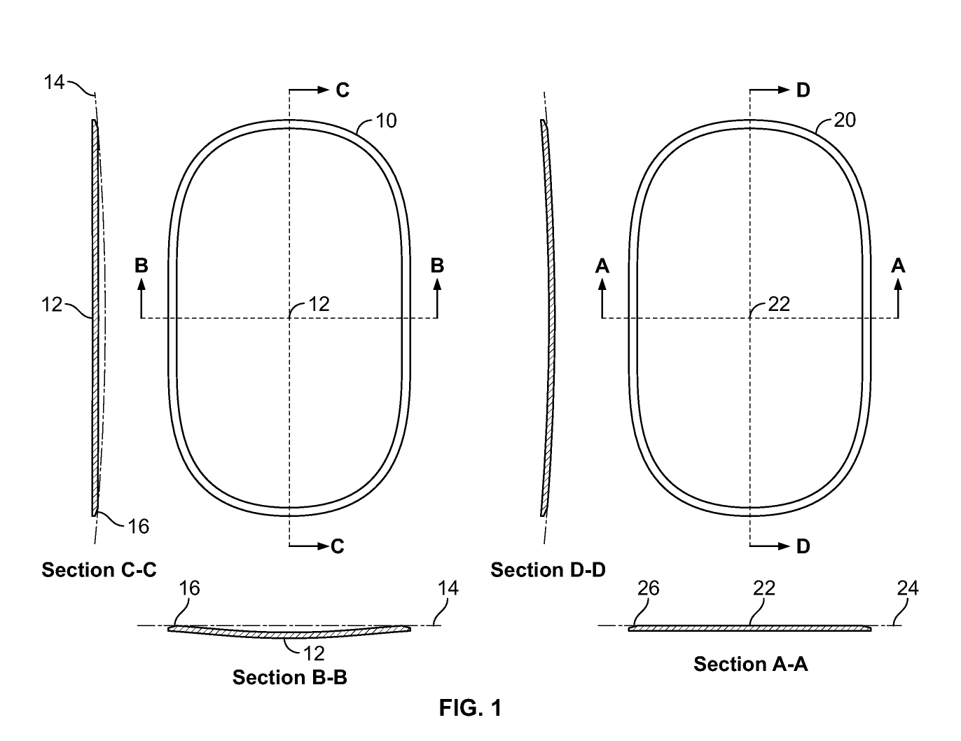

Referring now to the drawings, and particularly to FIG. 1 thereof, there is shown a multi-perspective view of a low drag passenger window 10 in accordance with an embodiment of the present invention, compared to a traditional passenger window 20. The low drag passenger window 10 utilizes the approach that the as-manufactured geometry of the window must be modified so that the shape of the window while under typical cruise conditions is aerodynamically optimized. The shape of the low-drag window 10 is such that the edge of the window 10 mates to the aircraft structure 16 at installation as well as while pressurized. The window is manufactured with a compound curved shape that places the center of the window 12 offset inward relative to the aircraft theoretical loft surface 14 when installed in the aircraft. Aircraft fuselages generally have a cylindrical geometry and so the traditional cabin window 20 is manufactured with a cylindrical curvature matching that of the aircraft. As such, the center 22 of the traditional window 20 is curved slightly outward.

Under typical cruising conditions, the center of the window deflects outward due to pressurization and temperature changes. The as-manufactured curvature of the traditional window 20 matches the aircraft, so that under cruise conditions, the center 22 deflects outward and no longer matches the cylindrical curvature of the aircraft. Conversely, when cruise conditions cause the low drag window 10′s inwardly offset center 12 to deflect slightly outward, the low drag window 10 would form a cylindrical curvature nearly matching that of the aircraft. In this way, the low drag cabin window 10 will approach the geometry of the traditional cabin window 20 when subjected to aircraft service pressures and temperatures. The shape of the low drag window 10 becomes aerodynamically optimized under cruise conditions, whereas the traditional window 20 is aerodynamically optimized at ground level. This is advantageous due to the fact that the majority of a typical flight takes place at cruise conditions. The traditional window 20 is most aerodynamic during takeoff and landing, removing drag from these portions of the flight, but places a “drag penalty” while the aircraft is at cruising altitude. The low drag window 10 places the “drag penalty” on the shortest parts of the flight, takeoff and landing, and decreases drag during the longest portion of the flight. This low drag design can be applied to air gap window designs, laminated window designs, or low pressure fairing pane designs. This concept may also be retrofit into existing air gap window assemblies by replacing the outer pane with no seal or mating structure changes required.

The design goal of the low-drag window is to make the outside contour of an airplane as aerodynamic as possible during operation. The conventional passenger window is designed with its unpressurized outside mold line (OML) surface geometry matching the airplane's cylindrical fuselage surface. However, during operation, the cabin pressure differential tends to deflect the window outward and reduce the aircraft's external aerodynamic smoothness. As a result, the aerodynamic drag increases. The higher the drag developed, the less the operating fuel efficiency.

To improve the operating fuel efficiency, the low drag window 10 is designed to maintain its pressurized transparency curvature matching the aircraft external fuselage surface at operating service conditions. This is accomplished by inwardly offsetting the original cylindrical OML surface through a computer-aided forming operation. The final computer generated window surface resolves the window's additional deflection during flight. This final window shape is obtained by iterating the window geometry, exerted by the pressure differential, in a level flight to match the desired after-deformed geometry—a cylindrical shape. In each iteration run, the window's nodal points are offset inward to neutralize its outward deflection until all the nodes on the final deformed OML surface match the desired surface within a tight tolerance, i.e., a smoothly aerodynamic low-drag window surface is developed.

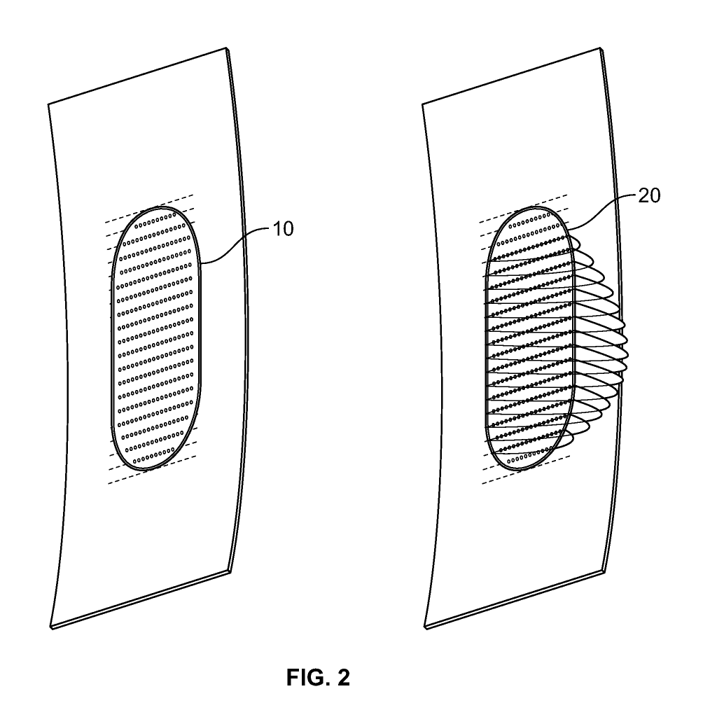

FIG. 2 demonstrates the aerodynamic advantage that can be achieved with a low drag window 10 in accordance with an embodiment of the present invention by comparing deformed windows under cruise conditions. The cruise conditions assumed for purposes of FIG. 2 were an inside surface temperature of 30° F., an outside surface temperature of −40° F., and a pressure differential of 8 psi. The vectors show the distance from the outside mold line of a fuselage with a radius of 112.93 inches. Under these assumed cruise conditions, the traditional window 20 may deflect up to 0.405″ from the outer mold line of the aircraft fuselage. Conversely, the low drag window 10 deflects a maximum of 0.020″ from the outer mold line of the aircraft fuselage. This translates into decreased drag, which yields greater fuel efficiency.

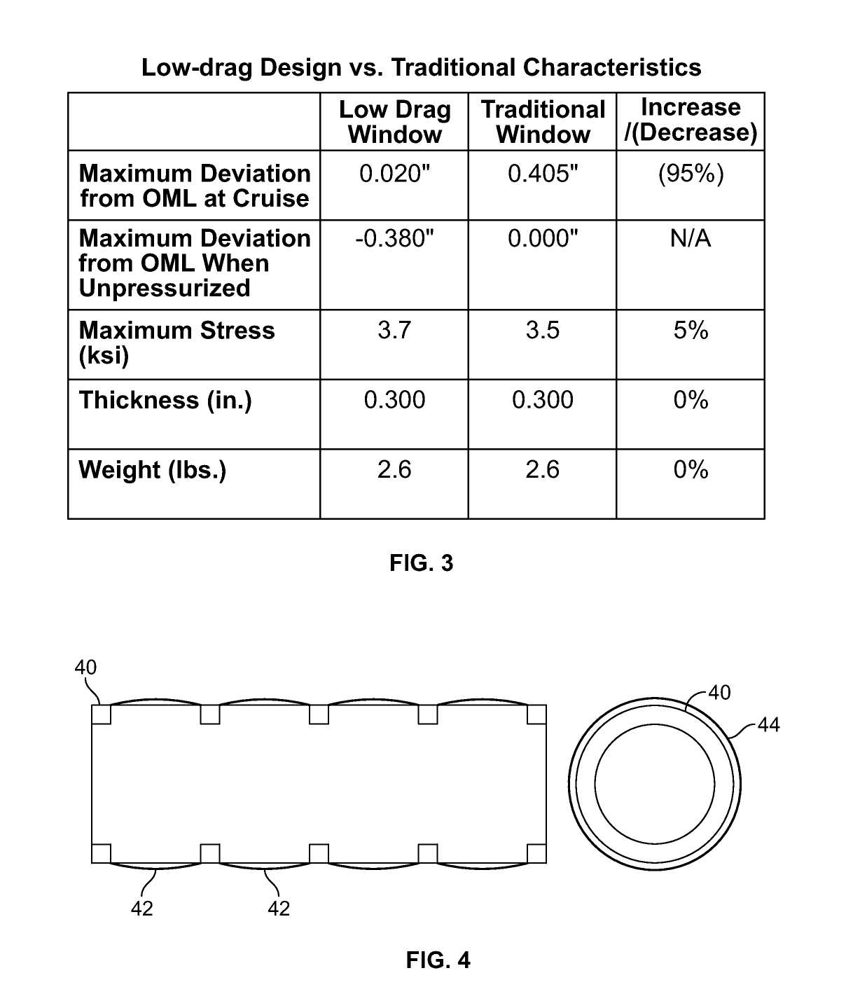

FIG. 3 demonstrates the diagram of FIG. 2 in chart form, along with some additional information. In one embodiment of the present invention, the center 12 of the low drag window 10 is inwardly offset by 0.380″ at unpressurized conditions, whereas the traditional window 20's center 22 is not offset at all compared to the cylindrical curvature of the aircraft. It will be understood by those of ordinary skill in the art that the magnitude of the inward offset is determined by multiple factors, such as the material, thickness, size, and shape of the window, as well as the desired optimal curvature, the assumed cruise altitude and conditions, temperature gradient, etc. As was demonstrated in FIG. 2, this difference in unpressurized conditions could lead to similar differences at pressurized, cruise conditions, where the traditional window 20 deflects up to 0.405″ from the curvature of the aircraft and the low drag window 10 deflects only 0.020″ from the OML of the aircraft. In the demonstrated embodiment, the low drag window 10 is of the same thickness and weight as the traditional window 20. In this way, there is a gain in overall aerodynamic efficiency while not producing any weight penalty at all. It should be understood that the numbers given in FIGS. 2 and 3 are simply for the purpose of demonstration and different numbers may apply for different sizes and types of aircraft windows.

If the change in initial geometry is too large, this could result in appearance changes, noise during climb and descent, and also excessive drag during climb and descent. It should be understood by those of ordinary skill in the art that these factors can be controlled by adjusting the pane thickness in combination with a reduced change in initial geometry. It should also be understood that cruise conditions may be too variable for one optimal design, in which case the design should be based on the most likely conditions.

When an aircraft enters pressurized cruise conditions, the windows are not the only parts of the plane that deflect outwards. FIG. 4 displays a simplified schematic of a fuselage deformed due to internal pressure loads. Under cruise conditions, the airplane fuselage 40 may become deformed due to pressure loads. The nominal cylindrical fuselage 40 will become a compound curved surface due to deformed fuselage skins 42. Low drag passenger windows 10 may be designed to match the cylindrical fuselage shape 40 when pressurized, but in another embodiment, they may also be designed to match the deformed fuselage shape 44. Finite element analysis (FEA) and computer aided design (CAD) tools may be used to predict and simulate the deformed shape of the window 10 under operating conditions. These simulations may then be used to design the window to approach the cylindrical curvature of the airplane fuselage under cruise conditions. These tools may also be used to predict the shape of the deformed airplane fuselage 44, so that low drag windows 10 may be designed to approach the curvature and shape of the deformed airplane fuselage 44 at cruise conditions.

Although the invention has been disclosed with reference only to the presently preferred embodiments, those of ordinary skill in the art will appreciate that various modifications can be made without departing from the invention. Accordingly, the invention is defined only by the following claims.

What is claimed is:

1. A low drag passenger cabin window for use on an aircraft fuselage having a generally cylindrical shape, the window comprising:
a pane of transparent material having an outer surface and an inner surface, the pane further having a peripheral portion and a medial portion,
the inner and outer surfaces of the peripheral portion of the pane conforming to a generally cylindrical shape, and
the inner and outer surfaces of the medial portion of the pane depressed inwardly in a prescribed manner relative to the cylindrical shape of the peripheral portion, wherein the magnitude of the depression of the surfaces of the medial portion relative to the peripheral portion gradually increases from the peripheral portion toward the center of the medial portion.

2. The low drag passenger cabin window of claim 1, wherein the surfaces of the medial portion are adapted to deflect outwardly to conform to a generally cylindrical shape in response to a predetermined air pressure differential between the inner and outer surfaces of the pane.

3. The low drag passenger cabin window of claim 2, wherein the surfaces of the medial portion are further adapted to deflect outwardly to conform to a generally cylindrical shape in response to a predetermined temperature gradient on the pane.

4. The low drag passenger cabin window of claim 2, wherein the surfaces of the medial portion deflect to a generally cylindrical shape substantially conforming to the generally cylindrical shape of the peripheral portion.

5. The low drag passenger cabin window of claim 4, wherein the surfaces of the medial portion deflect to within 0.02″ of the generally cylindrical shape of the peripheral portion.

6. The low drag passenger cabin window of claim 2, wherein the surfaces of the medial portion deflect to a generally cylindrical shape extending beyond the generally cylindrical shape of the peripheral portion.

7. The low drag passenger cabin window of claim 1, wherein the periphery of the pane approximates an elliptical shape.

8. The low drag passenger cabin window of claim 1, wherein the pane comprises a plastic material.

9. The low drag passenger cabin window of claim 8, wherein the pane comprises an acrylic plastic material.

10. The low drag passenger cabin window of claim 9, wherein the acrylic plastic material comprises a stretched acrylic.

11. The low drag passenger cabin window of claim 1, wherein the pane is a monolithic structure.

12. The low drag passenger cabin window of claim 1, wherein the pane is a multi-layered structure.

13. The low drag passenger cabin window of claim 12, wherein the pane comprises a laminated structure.

14. The low drag passenger cabin window of claim 1, wherein the pane has a thickness of less than about one-half inch.

15. The low drag passenger window of claim 1 comprising an air gap design.

16. The low drag passenger window of claim 1 comprising a low pressure fairing pane design.

17. The low drag passenger window of claim 1, wherein the magnitude of the depression of the medial portion relative to the peripheral portion is approximately 0.380″.
